(19) United States
(12) Patent Application Publication
(10) Pub. No.: US 2008/0155782 A1
(43) Pub. Date: Jul. 3, 2008

(54) Hinge assembly

(75) Inventors: Jung-Bin Chang, Shulin City (TW); Tzu-Yu Lin, Shulin City (TW)

Correspondence Address: COOPER & DUNHAM, LLP, 1185 AVENUE OF THE AMERICAS, NEW YORK, NY, 10036, US

(73) Assignee: Shin Zu Shing Co, Ltd.

(21) Appl. No.: 11/649,100

(22) Filed: Jan. 3, 2007

(51) Int. Cl. E05D 7/00

(52) U.S. Cl. 16/224

(57) ABSTRACT

A hinge assembly is mounted between a cover and a main case of an electronic appliance and has a base, a rotating bracket, two sleeves, a positioning spacer and a positioning assembly. The base connects to the main case and has a receiving hole. The rotating bracket has a central shaft and two side shafts. The sleeves connect to the cover and are mounted around the side shaft. The positioning spacer is mounted securely on the central shaft and has a positioning detent selectively aligning with the receiving hole. The positioning assembly is mounted in the receiving hole of the base and selectively engages the positioning detent. When the cover is rotated relative to the main case along the longitudinal axis, the central shaft rotates the positioning spacer relative to the positioning assembly. When the positioning assembly engages the positioning detent, the cover is positioned relative to the main case.

### BACKGROUND OF THE INVENTION

1. Field of the Invention

The present invention relates to a hinge assembly, especially to a hinge assembly mounted between a cover and a main case of an electronic appliance to allow the cover being opened, closed or rotated relative to the main case.

2. Description of the Prior Arts

Electrical appliances such as notebook computers, cell phones, etc. have a cover, a main case and a conventional hinge. The conventional hinge connects the cover to the main case along a transverse axis and a longitudinal axis to allow the cover to pivot relative to the main case. When the cover is rotated relative to the main case, the conventional hinge keeps the cover in position with friction between the components of the conventional hinge. After the electronic appliances are used for a long time, the hinge wears, and the friction of the hinge is not sufficient to hold the cover in position.

To overcome the shortcomings, the present invention provides a hinge assembly to mitigate or obviate the aforementioned problems.

### SUMMARY OF THE INVENTION

The main objective of the present invention is to provide a hinge assembly with positioning function. The hinge assembly is mounted between a cover and a main case of an electronic appliance and has a base, a rotating bracket, two sleeves, a positioning spacer and a positioning assembly. The base connects to the main case and has a receiving hole. The rotating bracket has a central shaft and two side shafts. The sleeves connect to the cover and are mounted around the side shaft. The positioning spacer is mounted securely on the central shaft and has a positioning detent selectively aligning with the receiving hole. The positioning assembly is mounted in the receiving hole of the base and selectively engages the positioning detent. When the cover is rotated relative to the main case along the longitudinal axis, the central shaft rotates the positioning spacer relative to the positioning assembly. When the positioning assembly engages the positioning detent, the cover is positioned relative to the main case.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge assembly in accordance with the present invention;

FIG. 2 is an exploded perspective view of the hinge assembly in FIG. 1;

FIG. 3 is a top view of the hinge assembly in FIG. 1;

FIG. 4 is a side view in partial section of the hinge assembly along line 4-4 in FIG. 3;

FIG. 5 is an exploded perspective view of a part of another embodiment of a hinge assembly in accordance with the present invention;

FIG. 6 is a top view of a part of the hinge assembly in FIG. 5; and

FIG. 7 is a side view in partial section of a part of the hinge assembly along line 7-7 in FIG. 6.

### DETAILED DESCRIPTION OF THE PREFERRED EMBODIMENTS

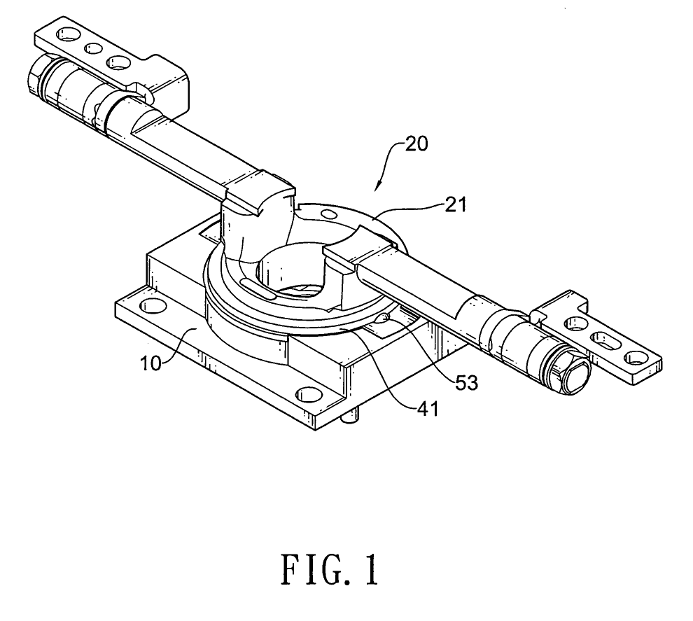

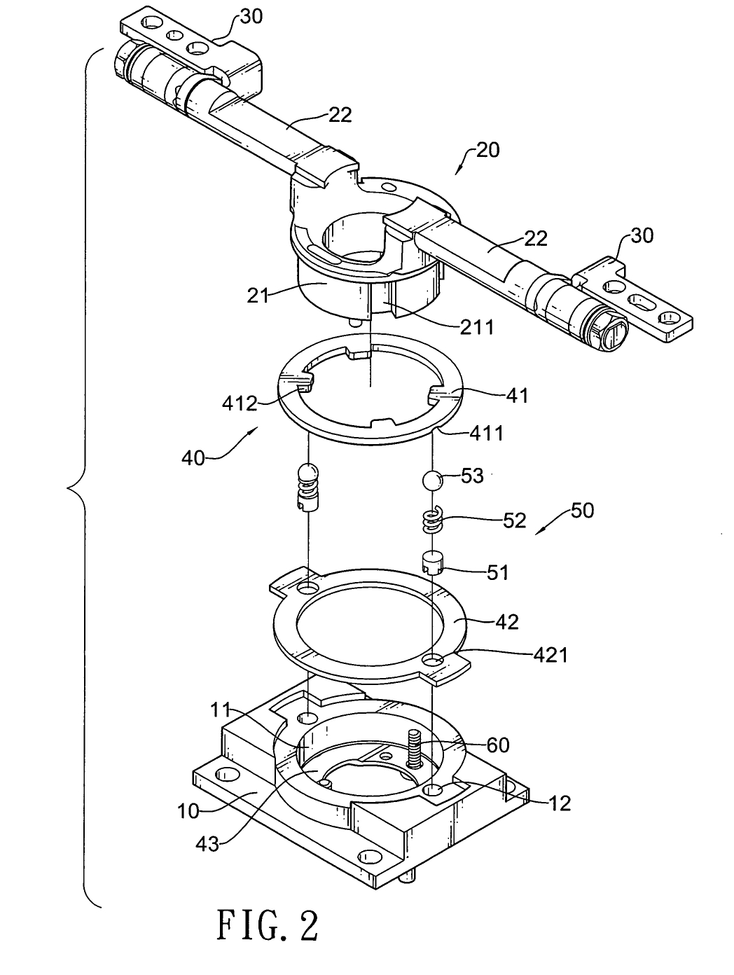

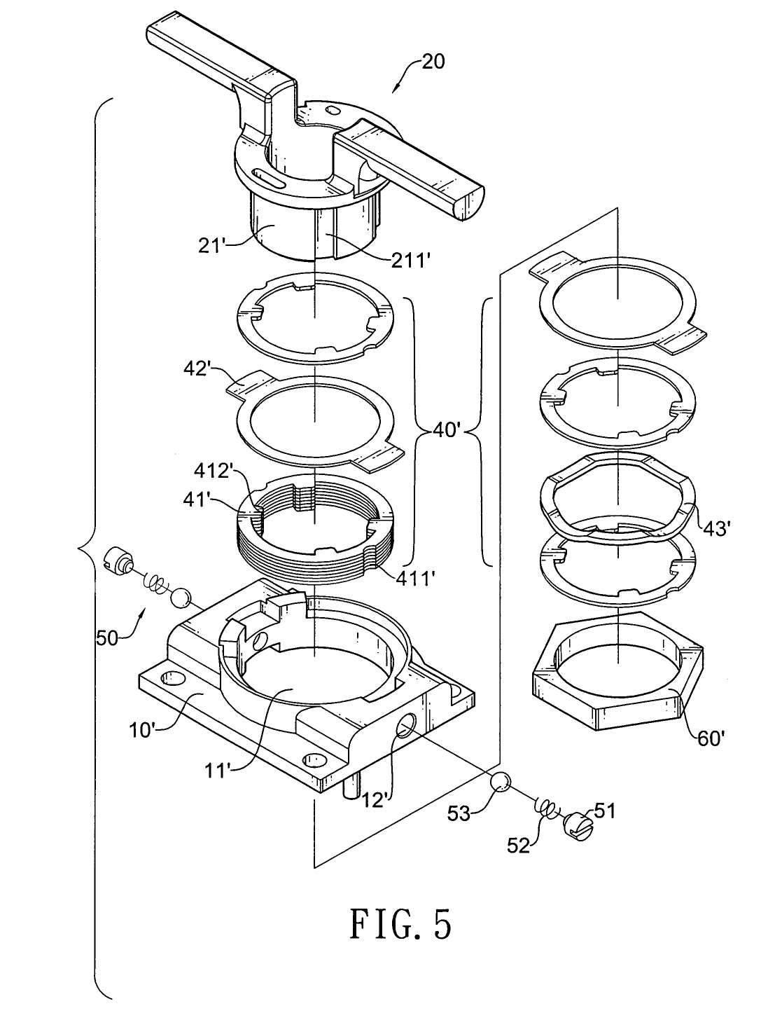

With reference to FIGS. 1, 2 and 5, a hinge assembly in accordance with the present invention comprises a base (10, 10′), a rotating bracket (20, 20′), two sleeves (30), a spacer assembly (40, 40′), two positioning assemblies (50) and multiple fasteners (60, 60′).

The base (10, 10′) has a top, a sidewall, a central hole (11, 11′) and two receiving holes (12, 12′). The receiving holes (12) are formed longitudinally in the top of the base (10) near the central hole (11), or the receiving holes (12′) are respectively formed transversely in the sidewall of the base (10′) and communicate with the central hole (11′).

The rotating bracket (20, 20′) connects to the base (10, 10′) and has a central shaft (21, 2 1′) and two side shafts (22, 22′). The central shaft (21, 21′) is mounted rotatably in the central hole (11, 11′) of the base (10, 10′) and has a bottom, a top, a sidewall and multiple longitudinal grooves (211, 211′). The longitudinal grooves (211, 211′) are formed radially in the sidewall of the central shaft (21, 21′). The side shafts (22) extend radially out of the top of the central shaft (21) and are opposite to each other.

The sleeves (30) are mounted respectively and rotatably around the side shafts (22) of the rotating bracket (20).

The spacer assembly (40, 40′) connects to the base (10, 10′) and the rotating bracket (20, 20′) and comprises at least one positioning spacer (41, 41′), multiple rubbing spacers (42, 42′) and multiple resilient spacers (43, 43′).

The positioning spacer (41, 41′) is mounted securely on the central shaft (21, 21′). The positioning spacers (41′) may be mounted in the central hole (11′) of the base (10′). Each positioning spacer (41, 41′) has an inside wall, an outside wall, a bottom surface, multiple fastening protrusions (412, 412′) and two positioning detents (411, 411′). The fastening protrusions (412, 412′) are formed radially on the inside wall of the positioning spacer (41, 41′) and engage the longitudinal grooves (211, 211′) of the central shaft (21, 21′) to mount the positioning spacer (41, 41′) securely on the central shaft (21, 21′). The positioning detents (411) are formed in the bottom surface of the positioning spacer (41) and selectively align with the receiving holes (12) formed in the top of the base (10), or the positioning detents (411′) are formed radially in the outside walls of the positioning spacers (41′) and selectively align with the receiving holes (12′) formed transversely in the sides of the base (10′).

The rubbing spacers (42, 42′) are mounted around the central shaft (21, 21′) to reduce the friction. One of the rubbing spacer (42) may be mounted securely in the central hole (11) of the base (10) and has at least one through hole (421) aligning with the receiving hole (12) of the base (10).

The resilient spacers (43, 43′) are mounted around the central shaft (21, 21′) to press the spacer assembly (40, 40′) tightly. One of the resilient spacer (43) may be attached to the bottom of the central shaft (21).

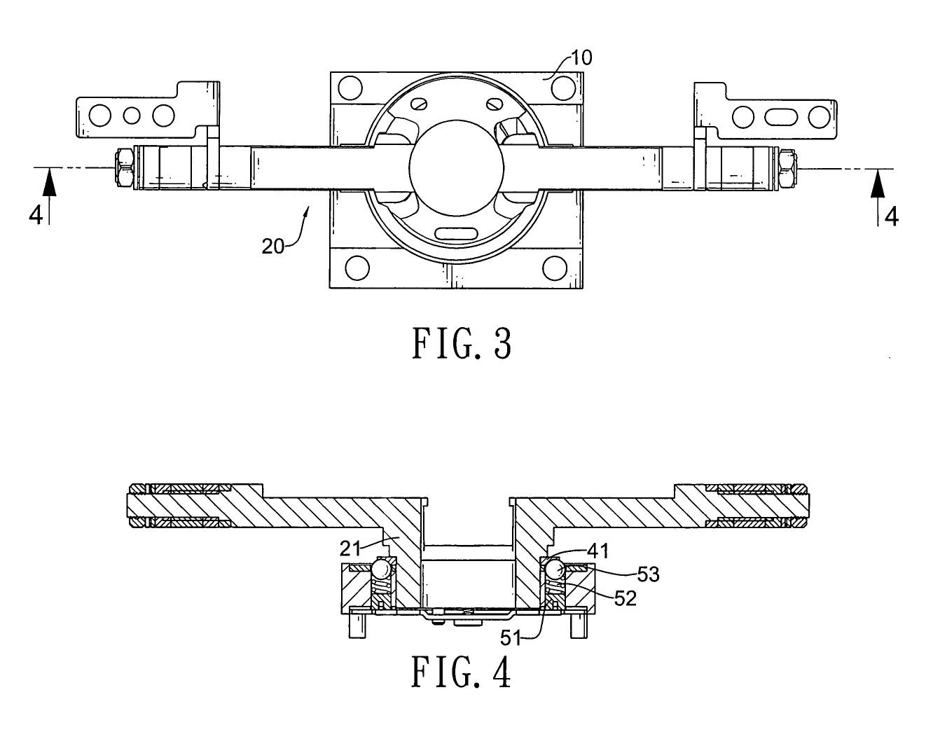

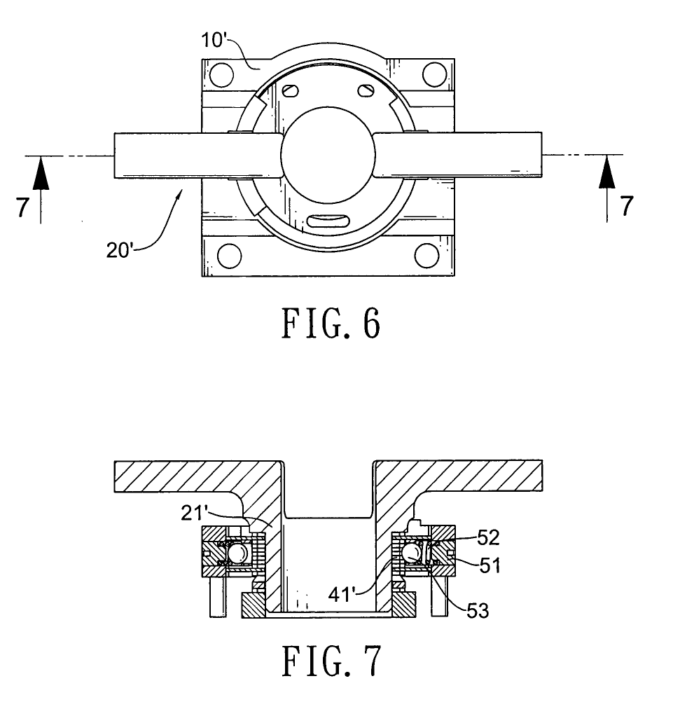

With further reference to FIGS. 3, 4, 6 and 7, the positioning assemblies (50) are mounted respectively in the receiving holes (12, 12′) of the base (10, 10′). Each positioning assembly (50) comprises a seat (51), a ball (53) and a spring (52). The seat (51) is mounted securely in the corresponding receiving hole (12, 12′) of the base (10, 10′). The ball (53) is mounted in and extends out of the corresponding receiving hole (12, 12′) of the base (10, 10′) and selectively engages the positioning detents (411, 411′) of the positioning spacers (41, 41′). The ball (53) may extend into the through hole (421) of the rubbing spacer (42) or may extend into the central hole (11′) of the base (10′). The spring (52) is mounted in the corresponding receiving hole (12, 12′) of the base (10, 10′) and presses the ball (53) to extend out of the corresponding receiving hole (12, 12′) of the base (10, 10′).

The fasteners (60, 60′) connect securely to the bottom of the central shaft (21, 21′). The fasteners (60) may be screws and may extend through the resilient spacer (43) and be screwed onto the bottom of the central shaft (21) to mount the fasteners (60) securely in the central shaft (21). The fastener (60′) may be a washer mounted around the central shaft (21′), and the bottom of the central shaft (21′) is riveted to the washer to attach the fastener (60′) securely to the bottom of the central shaft (21′).

The hinge assembly as described is mounted between a cover and a main case of an electronic appliance. The sleeves (30) connect securely to the cover. The base (10, 10′) connects securely to the main case.

When the cover is opened or closed relative to the main case, the cover rotates the sleeves (30) relative to the rotating bracket (20) and the base (10).

When the cover is rotated along the transverse axis relative to the main case, the cover rotates the rotating bracket (20, 20′) relative to the base (10, 10′). Then the central shaft (21, 21′) rotates the positioning spacers (41, 41′) relative to the positioning assemblies (50). When the positioning detents (411, 411′) of the positioning spacers (41, 41′) engage the balls (53) of the positioning assemblies (50), the cover is positioned at a predetermined angle relative to the main case. Therefore, the hinge assembly as described not only provides positioning function by the friction between all of the components but also provides the positioning function by the positioning spacers (41, 41′) and the positioning assemblies (50).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge assembly comprising:
a base having
a central hole; and
at least one receiving hole formed in the base;
a rotating bracket connecting to the base and having
a central shaft mounted rotatably in the central hole of the base and having a bottom and a top; and
two side shafts extending radially out of the top of the central shaft and being opposite to each other;
two sleeves mounted respectively around the side shafts;
a spacer assembly mounted around the central shaft and comprising
at least one positioning spacer mounted securely on the central shaft, and each one of the at least one positioning spacer having at least one positioning detent selectively aligning with the receiving hole of the base;
at least one positioning assembly connecting to the base, and each one of the at least one positioning assembly mounted in a corresponding receiving hole of the base and comprising
a seat mounted securely in the corresponding receiving hole of the base;
a ball mounted in and extending out of the corresponding hole of the base and selectively engaging the at least one positioning detent of a corresponding one of the at least one positioning spacer; and
a spring mounted in the corresponding receiving hole of the base and pressing the ball to extend out of the corresponding receiving hole; and
at least one fastener connecting securely to the bottom of the central shaft.

2. The hinge assembly as claimed in claim 1, wherein
the base has a top;
the at least one receiving hole is formed axially in the top of the base;
each one of the at least one positioning spacer has a bottom surface; and
the at least one positioning detent is formed in the bottom surface of each one of the at least one positioning spacer.

3. The hinge assembly as claimed in claim 1 further having multiple positioning spacers, wherein
the base has a sidewall;
the at least one receiving hole is formed in the sidewall of the base and communicates with the central hole of the base;
each one of the at least one positioning spacer has an outside wall;
the at least one positioning detent is formed radially in the outside wall of each positioning spacer.

4. The hinge assembly as claimed in claim 2, wherein
the spacer assembly has a rubbing spacer mounted securely in the central hole of the base, mounted around the central shaft and having at least one through hole aligning with the at least one receiving hole of the base; and
the ball of each one of the at least one positioning assembly extends into a corresponding one through hole of the rubbing spacer.

5. The hinge assembly as claimed in claim 3, wherein the spacer assembly has multiple rubbing spacer mounted around the central shaft and mounted in the central hole of the base.

6. The hinge assembly as claimed in claim 4 further having multiple fasteners, wherein
the spacer assembly has a resilient spacer attached to the bottom of the central shaft; and
the fasteners are screws, extend through the resilient spacer and are screwed onto the bottom of the central shaft.

7. The hinge assembly as claimed in claim 5, wherein the hinge assembly has a single fastener, wherein
the spacer assembly has multiple resilient spacers mounted around the central shaft and mounted in the central hole of the base;
the fastener is a washer mounted around the central shaft; and
the bottom of the central shaft is riveted to the washer.

8. The hinge assembly as claimed in claim 1, wherein
the central shaft has
a sidewall; and
multiple longitudinal grooves formed radially in the sidewall of the central shaft; and
each one of the at least one positioning spacer has
an inside wall; and
multiple fastening protrusions formed radially on the inside wall of the positioning spacer and engaging the longitudinal grooves of the central shaft.
